(19) United States
(12) Patent Application Publication
(10) Pub. No.: US 2014/0039950 A1
(43) Pub. Date: Feb. 6, 2014

(54) AUTOMATICALLY DETECTING LOST SALES

(71) Applicants: ANA PAULA APPEL, Sao Paulo (BR); Maira Athanazio de Cerqueira Gatti, Rio de Janeiro (BR); Rogerio Abreu de Paula, Sao Paulo (BR)

(72) Inventors: ANA PAULA APPEL, Sao Paulo (BR); Maira Athanazio de Cerqueira Gatti, Rio de Janeiro (BR); Rogerio Abreu de Paula, Sao Paulo (BR)

(73) Assignee: International Business Machines Corporation, Armonk, NY (US)

(21) Appl. No.: 13/566,253

(22) Filed: Aug. 3, 2012

(51) Int. Cl. G06Q 10/06

(52) U.S. Cl. 705/7.11

(57) ABSTRACT

One embodiment of a method for detecting a lost sale due to an out-of-shelf condition in a retail environment includes automatically detecting when a customer fails to purchase an expected product, based at least in part on an observation of a current behavior of the customer in the retail environment and on a purchasing history of the customer, and inferring, based on the automatically detecting, that the expected product is out-of-shelf.

### BACKGROUND OF THE INVENTION

The present invention relates generally to retail analytics and relates more specifically to the detection of lost sales in a retail environment.

The term “out-of-shelf” is commonly used in the retail industry to describe the condition in which a customer does not find on the shelf a product that he wishes to purchase. Out-of-shelf extends the “out-of-stock” case. That is, if a product is out-of-stock in a store, it is also necessarily out-of-shelf. However, an out-of-shelf product is not necessarily out-of-stock. For instance, the product may still be available in a storeroom facility, but unavailable on the shelf because the store personnel have not replenished the shelves.

Out-of-shelf conditions are a problem for the retail industry because they result in lost sales and reduced customer loyalty as customers shop elsewhere for the desired products. For instance, it has been estimated that financial losses due to out-of-shelf conditions can account for five to ten percent of a retailer's total revenue. This problem is especially significant in retail environments where product turnover is high, such as in grocery stores.

Conventional solutions for identifying out-of-shelf conditions do not differentiate between out-of-shelf products that are demanded by customers and out-of-shelf products that are not demanded by customers. For instance, even though a product may be out-of-shelf, this does not necessarily mean that any customers want to buy it. Thus, not all out-of-shelf conditions will necessarily result in lost sales.

### SUMMARY OF THE INVENTION

One embodiment of method for detecting a lost sale due to an out-of-shelf condition in a retail environment includes automatically detecting when a customer fails to purchase an expected product, based at least in part on an observation of a current behavior of the customer in the retail environment and on a purchasing history of the customer, and inferring, based on the automatically detecting, that the expected product is out-of-shelf.

### BRIEF DESCRIPTION OF THE DRAWINGS

So that the manner in which the above recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating one embodiment of a system for automatically detecting lost sales, according to the present invention;

FIG. 2 is a flow diagram illustrating one embodiment of a method for automatically detecting lost sales, according to the present invention; and

FIG. 3 is a high-level block diagram of the lost sale detection method that is implemented using a general purpose computing device.

### DETAILED DESCRIPTION

In one embodiment, the invention is a method and apparatus for automatically detecting lost sales. Embodiments of the invention in particular detect lost sales due to out-of-shelf conditions. For instance, embodiments of the invention evaluate historical data relating to a customer's purchasing habits as well as the customer's present purchases and behaviors in order to automatically infer out-of-shelf conditions related to demanded products. These inferences can be used to objectively identify lost sales and minimize revenue loss.

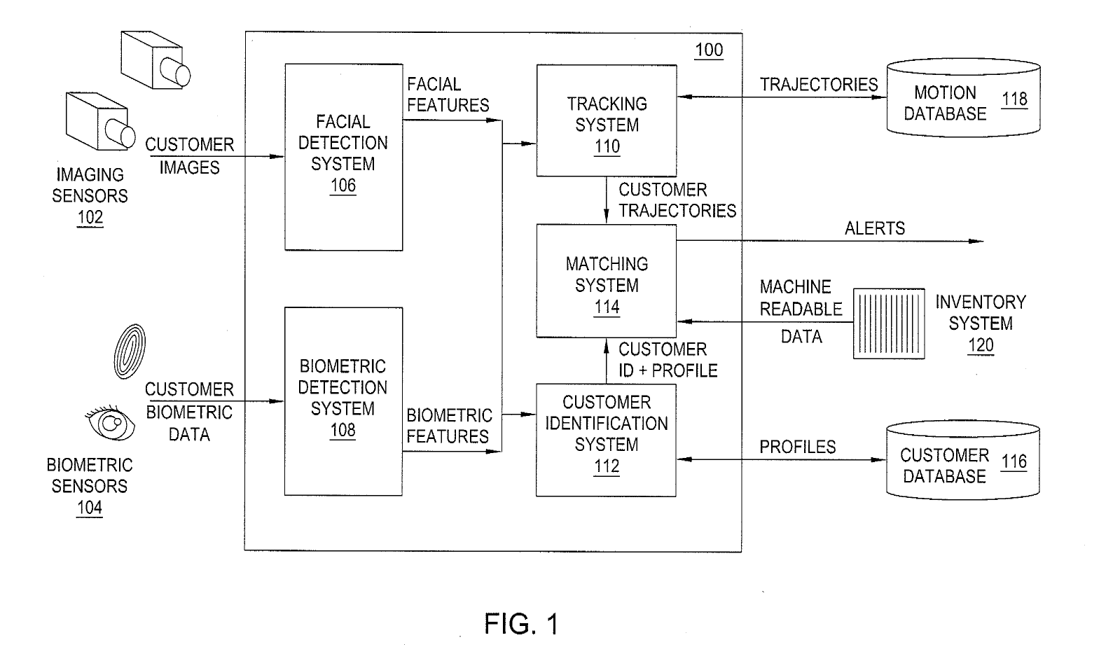

FIG. 1 is a block diagram illustrating one embodiment of a system 100 for automatically detecting lost sales, according to the present invention. Embodiments of the system 100 rely on automatic identification and data capture techniques to evaluate customer behavior and draw conclusions therefrom. The system 100 cooperates with a plurality of sensors, including, for example one more of: imaging sensors 102 (e.g., still cameras, video cameras, or the like) or biometric sensors 104 (e.g., fingerprint sensors, ocular sensors, voice sensors, or the like). Further embodiments may include radio frequency identification (RFID) sensors or sensors that detect machine-readable data (e.g., linear and matrix barcodes, uniform resource locators (URLs), or the like). These sensors 102-104 collect data from various physical locations within a retail environment. For instance, any one or more of the sensors 102-104 may be positioned to collect data at the entrances and exits of the retail environment, from individual sections, aisles, or shelves of the retail environment, from the cashier stations of the retail environment, or from any other location.

The system 100 subscribes to the outputs of the sensors 102-104 and comprises a plurality of components configured to process these outputs. In one embodiment, these components include: a facial detection system 106, a biometric detection system 108, a tracking system 110, a customer identification system 112, and a matching system 114. Any of the components 106-114 may comprise a processor configured to perform specific functions related to automatically detecting lost sales.

The facial detection system 106, for example, receives customer images captured by the imaging sensors 102 and processes these images in order to detect the facial regions of the images (i.e., the portions of the images that display customers' faces). Any one or more of a number of known techniques may be used for detecting the facial features in the images. In one embodiment, the facial detection system 106 additionally performs one or more post-processing techniques on the images in order to facilitate downstream processing. These post-processing techniques might include, for example, motion or blur compensation, noise reduction, sharpening, brightness or contrast adjustment, or the like. Additionally, in one embodiment, the facial detection system 106 may encrypt the captured images.

The biometric detection system 108 receives biometric data captured by biometric sensors 104 and processes the biometric data in order to detect biometric features of customers. These biometric features can include both physiological features and behavioral features. Physiological features detected by the biometric detection system 108 may include, for example, a customer's fingerprint or ocular (e.g., retina or iris) image. Behavioral features detected by the biometric detection system 108 may include, for example, a customer's gestures or gait. In one embodiment, the biometric detection system 108 additionally performs one or more post-processing techniques on the biometric data in order to facilitate downstream processing. These post-processing techniques might include, for example, noise reduction, endpoint detection, or the like. Additionally, in one embodiment, the biometric detection system 108 may encrypt the biometric data.

The tracking system 110 receives the facial features and biometric features and processes this information in order to monitor a particular customer's movements through the retail environment. Any one or more of a number of known techniques may be used for correlating the information and generating customer trajectories therefrom. In one embodiment, the tracking system 110 stores the customer trajectories in a motion database 118 that indexes the trajectories according to the customers with whom the trajectories are associated. This allows the system 100 to detect when a customer enters and exits the retail environment, stops in a particular section of the retail environment, or resumes a paused trajectory, as discussed in greater detail below.

The customer identification system 112 receives the facial features and biometric features and processes this information in order to identify a particular customer who is present in the retail environment. Any one or more of a number of known identification techniques may be used for correlating the information and generating a customer identification therefrom, including facial recognition, biometric recognition, or the like. In one embodiment, the customer identification system 112 accesses a customer database 116 that stores profiles for known customers. In a further embodiment, the customer identification system 112 generates a new profile for a new (or not recognized) customer and stores this new profile in the customer database 116. In a further embodiment still, the customer identification system 112 updates an existing customer profile with newly discovered customer data (e.g., new purchasing history information). A profile for a particular customer might include, for example, a unique identification or account number associated with the customer, the customer's image or other identifying biometric features, the customer's name, the customer's preferences, or the customer's purchasing history (i.e., data relating to products that the customer has purchased in the retail environment in the past). This allows the system 100 to detect when a returning customer is present in the retail environment, thereby allowing the system 100 to utilize knowledge about the returning customer's purchase history, as discussed in greater detail below.

The matching system 114 correlates the customer trajectories from the tracking system 110 with the customer identifications from the customer identification system 112. In addition, the matching system 114 may receive machine-readable data from the retail environments inventory system 120. This machine-readable data may include, for example, bar codes or other identifying information for products that are offered for sale in the retail environment and products that are purchased by customers in the retail environment. This allows the system 100 to compare a customer's current purchases with his purchase history. Conclusions can be drawn from this comparison that relate to out-of-shelf conditions in the retail environment, as discussed in greater detail below. When the matching system 114 detects an out-of-shelf condition based on such a comparison, the matching system 114 generates an alert that is sent to an automated system or to a system administrator for further review, confirmation, and, if necessary, corrective action.

Although the system 100 is illustrated as comprising a plurality of individual components that perform discrete functions, it will be appreciated that any two or more of the illustrated components may be combined in a single component that performs multiple functions. Additionally, although the system 100 is illustrated as a contained system, it will be appreciated that the various components of the system 100 may be physically distributed throughout the retail environment (although still contained within the physical boundaries of the retail environment), and some of the components may even be located off-site (i.e., outside the physical boundaries of the retail environment). To this end, the various components of the system 100 may include a combination of wireless and physically connected devices.

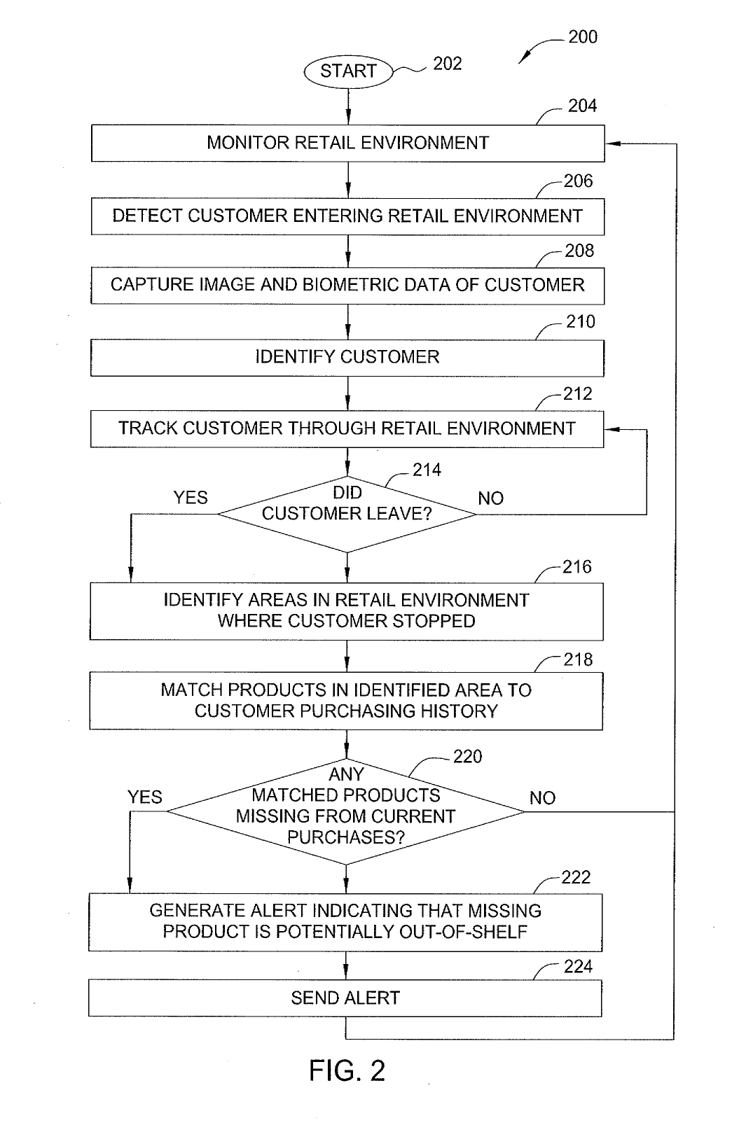

FIG. 2 is a flow diagram illustrating one embodiment of a method 200 for automatically detecting lost sales, according to the present invention. The method 200 may be performed, for example, by the system 100 illustrated in FIG. 1. As such, reference is made in the discussion of the method 200 to various elements depicted in FIG. 1. However, it will be appreciated that the method 200 may also be performed by systems having alternate configurations.

The method 200 begins at step 202 and proceeds to step 204, where the system 100 monitors a retail environment (e.g., a grocery store, a department store, a convenience store, or the like). In one embodiment, the monitoring involves the imaging sensors 102 and the biometric sensors 104 continually sending their outputs to the facial detection system 106 and the biometric detection system 108, respectively. The outputs comprise substantially real-time images and biometric data collected from various locations within the retail environment.

In step 206, the system 100 detects a customer entering the retail environment. For instance, the facial detection system 106 might detect a new face in the output of an imaging sensor 102 positioned near an entrance to the retail environment. A review of customer trajectories maintained in the motion database 118 may confirm that this customer is a new customer who has recently entered the retail environment.

In step 208, the system 100 captures the customer's images and biometric data, which serve to uniquely identify the customer. In one embodiment, the images and biometric data are captured by the imaging sensors 102 and biometric sensors 104, as discussed above. Thus, the images may include, for instance, still and/or video images of the customer. The biometric data may include, for example, the customer's fingerprints or ocular features.

In step 210, the system 100 identifies the customer in accordance with the customer's images and/or biometric data. In one embodiment, the customer identification system 112 matches the customer's images and/or biometric data to a profile in the customer database 116. As discussed above, if the customer identification system 112 cannot find a match for the customer's images and/or biometric data in the customer database 116, the customer identification system may create a new profile for the customer. In one embodiment, the customer is identified by a unique identification number or other identifier rather than by his name, in order to protect the customer's privacy.

In step 212, the system 100 tracks the customer through the retail environment. In one embodiment, the tracking system 110 receives the outputs of the imaging sensors 102 and/or biometric sensors 104 and correlates the outputs in order to identify outputs that are associated with the customer. For instance, a subset of the images output by the imaging sensors 102 may depict the customer. Once the outputs for the customer are correlated, the tracking system 110 can use the correlated outputs to construct a trajectory for the customer that traces his movements through the retail environment. For instance, the correlated outputs may indicate that after the customer entered the retail environment, he walked directly to a specific section of the retail environment and paused in this section for several minutes before continuing to the cashier station. In one embodiment, the trajectory traces the customer's movements between the time that the customer enters the retail environment and the time that the customer exits the retail environment. In one embodiment, the tracking system 110 constructs and updates the customer's trajectory in substantially real time (i.e., as the customer traverses the retail environment, rather than after the customer has left the retail environment). The tracking system 110 stores the customer's trajectory in the motion database 118.

In step 214, the system 100 determines whether the customer has left the retail environment. In one embodiment, the tracking system 110 detects when the customer's trajectory has exited the retail environment. For instance, outputs from the imaging sensors 102 and/or biometric sensors 104 may indicate that the customer's most recent detected location was near the exit of the retail environment. Alternatively, the outputs of imaging sensors 102 and/or biometric sensors 104 may fail to include any data associated with the customer for a threshold period of time, indicating that the customer's current location is likely beyond the monitoring area of the retail environment. Thus, the system 100 records the customer's time in the retail environment, between entry and exit, as a single “visit” to the retail environment. Within the context of the present invention, a “visit” to a retail environment is defined as the time spent in the retail environment between an entry and an immediately subsequent exit.

If the system 100 concludes in step 214 that the customer has not left the retail location, then the method 200 loops back to step 212, and the system 100 continues the track the customer through the retail environment. Alternatively, if the system 100 concludes in step 214 that the customer has left the retail location, then the method 200 proceeds to step 216.

In step 216, the system 100 identifies areas within the retail environment where the customer stopped during the visit. In one embodiment, the tracking system 110 reviews the customer trajectories in order to identify areas where the customer's motion was paused. Such pauses may indicate that the customer stopped in the indicated areas to search for particular products that are stocked in those areas.

In step 218, the system 100 matches products in the identified areas to the customer's purchasing history. In one embodiment, the matching system 114 retrieves a list of products that are stocked in the identified areas. This list may be retrieved from the retail environment's inventory and stock records. In addition, the matching system 114 retrieves the customer's customer profile from the customer database 116. The customer profile, as discussed above, may include a record of the customer's purchasing history (i.e., products purchased in the retail environment). The matching system 114 then identifies the matched products that occur in both the list of products that are stocked in the identified areas and in the customer's purchasing history. In one embodiment, the products are matched by brand name, bar code, or other identifying information. For instance, the matching system 114 may determine that the customer stopped in a section of the retail environment that sells Brand X orange juice, and that the customer often purchases Brand X orange juice.

In step 220, the system 100 determines whether any of the matched products are missing from the customer's current purchases made during the visit. In one embodiment, the matching system 114 retrieves the customer's current purchases from the inventory system 120 and identifies any matched products that do not occur in the customer's current purchases (e.g., as reported by the cashier station). It is noted that in the case where the customer leaves the retail environment without making any purchases, all of the matched products will be missing from the customer's current purchases.

If the system 100 concludes in step 220 that no matched products are missing from the customer's current purchases, then the method 200 loops back to step 204, and the system 100 continues to monitor the retail environment. Alternatively, if the system 100 concludes in step 220 that any of the matched products are missing from the customer's current purchases, then the method 200 proceeds to step 222.

In step 222, the matching system 114 generates an alert indicating that those matched products missing from the customer's current purchases are potentially out-of-shelf. In one embodiment, the matching system may consult the inventory system 120 before generating the alert, in order to confirm whether the missing matched products are out-of-shelf, out-of-stock, or simply in low supply. In step 224, the matching system sends the alert to an appropriate destination (e.g., the inventory system 120, a human operator, or the like). The alert assists the retail environment in detecting potential out-of-shelf conditions, so that such conditions can be remedied in a timely manner (e.g., before significant loss of sales).

After the alert is sent, the method 200 loops back to step 204, and the system 100 continues to monitor the retail environment as discussed above.

The system 100 can thus be employed to automatically detect or infer lost sales of out-of-shelf products through observation of customer behaviors (i.e., failure of the customer make an expected purchase). Moreover, because this inference is drawn at least in part from observed customer behaviors, it is more likely that the out-of-shelf products that are identified will be products that customers are actually seeking (and that therefore truly represent lost opportunities for sales). Thus, the present invention does not just detect when any product is out-of-shelf, but detects in particular when a product that a customer wants is out-of-shelf.

Although the method 200 is largely described within the context of the activities of a single customer, it is noted that steps 206-224 may be performed for every customer that is detected in the retail environment. Alternatively, steps 206-224 may be performed for a subset of the detected customers (e.g., only for detected customers whose profiles are present in the customer database 116).

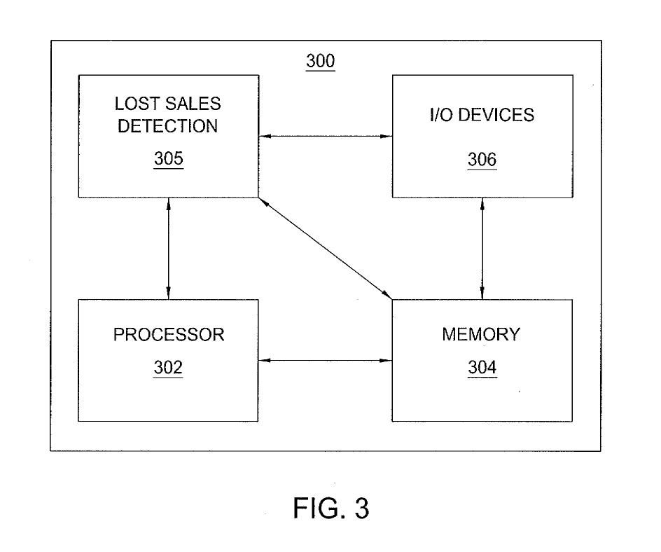

FIG. 3 is a high-level block diagram of the lost sale detection method that is implemented using a general purpose computing device 300. In one embodiment, a general purpose computing device 300 comprises a processor 302, a memory 304, a lost sale detection module 305 and various input/output (I/O) devices 306 such as a display, a keyboard, a mouse, a stylus, a wireless network access card, an Ethernet interface, and the like. In one embodiment, at least one I/O device is a storage device (e.g., a disk drive, an optical disk drive, a floppy disk drive). It should be understood that the lost sale detection module 305 can be implemented as a physical device or subsystem that is coupled to a processor through a communication channel.

Alternatively, the lost sale detection module 305 can be represented by one or more software applications (or even a combination of software and hardware, e.g., using Application Specific Integrated Circuits (ASIC)), where the software is loaded from a storage medium (e.g., I/O devices 306) and operated by the processor 302 in the memory 304 of the general purpose computing device 300. Thus, in one embodiment, the lost sale detection module 305 for automatically detecting lost sales, as described herein with reference to the preceding figures, can be stored on a computer readable storage medium (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying figures that recite a determining operation or involve a decision, do not necessarily require that both branches of the determining operation be practiced. In other words, one of the branches of the determining operation can be deemed as an optional step.

While the foregoing is directed to embodiments of the present invention, other and further embodiments of the invention may be devised without departing from the basic scope thereof. Various embodiments presented herein, or portions thereof, may be combined to create further embodiments. Furthermore, terms such as top, side, bottom, front, back, and the like are relative or positional terms and are used with respect to the exemplary embodiments illustrated in the figures, and as such these terms may be interchangeable.

1. A method for detecting a lost sale due to an out-of-shelf condition in a retail environment, the method comprising:
automatically detecting when a customer fails to purchase an expected product during a current visit to the retail environment, based at least in part on an observation of a behavior of the customer during the current visit and on a purchasing history of the customer, wherein the behavior indicates that the customer wishes to purchase the expected product during the current visit and the purchasing history identifies the expected product as a product that the customer purchased during a past visit to the retail environment; and
inferring, based on the automatically detecting, that the expected product is out-of-shelf, without necessarily being out-of-stock;
wherein at least one of the automatically detecting or the inferring is performed using a processor.

2. The method of claim 1, wherein the automatically detecting comprises:
identifying a first set of products stocked in a first section of the retail environment in which the customer stops during the current visit;
identifying the expected product in the first set of products and in the purchasing history of the customer;
identifying a purchase made by the customer during the current visit in the retail environment; and
detecting that the purchase does not include the expected product.

3. The method of claim 2, wherein the identifying the first set of products comprises:
tracking a movement of the customer through the retail environment;
detecting when the customer stops in the first section of the retail environment; and
retrieving a list of products stocked in the first section of the retail environment from an inventory system of the retail environment.

4. The method of claim 3, wherein the tracking comprises:
capturing identifying data that uniquely identifies the customer from a plurality of physical locations within the retail environment; and
correlating the identifying data in order to construct a trajectory that traces the movement of the customer through the retail environment.

5. The method of claim 4, wherein the identifying data comprises a plurality of images of the customer.

6. The method of claim 4, wherein the identifying data comprises biometric data of the customer.

7. The method of claim 6, wherein the biometric data comprises a fingerprint of the customer.

8. The method of claim 6, wherein the biometric data comprises an ocular feature of the customer.

9. The method of claim 6, wherein the biometric data comprises a gait of the customer.

10. The method of claim 6, wherein the biometric data comprises a gesture of the customer.

11. The method of claim 1, further comprising:
retrieving the purchasing history from a customer database comprising a plurality of customer profiles.

12. The method of claim 11, wherein the retrieving comprises:
capturing identifying data that uniquely identifies the customer from at least one physical location within the retail environment;
detecting a profile from the plurality of customer profiles that matches the identifying data; and
extracting the purchasing history from the profile.

13. The method of claim 12, wherein the identifying data comprises a plurality of images of the customer.

14. The method of claim 12, wherein the identifying data comprises biometric data of the customer.

15. The method of claim 14, wherein the biometric data comprises a fingerprint of the customer.

16. The method of claim 14, wherein the biometric data comprises an ocular feature of the customer.

17. The method of claim 14, wherein the biometric data comprises a gait of the customer.

18. The method of claim 12, wherein the identifying data is captured by a radio frequency identification system.

19. The method of claim 1, further comprising:
sending an alert indicating that the expected product is believed to be out-of-shelf.

20. A method for detecting a lost sale due to an out-of-shelf condition in a retail environment, the method comprising:
detecting an entry of a customer into a retail environment;
determining an identity of the customer;
retrieving a purchasing history associated with the customer, in accordance with the identity;
tracking a movement of the customer through the retail environment;
detecting when the customer stops in a section of the retail environment after the entry, in accordance with the tracking;
identifying a product that is both stocked in the section of the retail environment and that appears in the purchasing history as having been purchased by the customer during a past visit to the retail environment;
detecting an exit of the customer from the retail environment;
inferring that the customer wished to purchase the product during a current visit to the retail environment occurring between a time of the entry and a time of the exit, based at least in part on the tracking, the detecting when the customer stops, and the identifying;
reviewing a purchase made by the customer during the current visit to the retail environment; and
inferring that the product is out-of-shelf when the product is not part of the purchase,
wherein at least one of: the detecting the entry, the determining, the retrieving, the tracking, the detecting when the customer stops, the identifying, the detecting the exit, the inferring that the customer wished to purchase the product, the reviewing, or the inferring is performed using a processor.
